(19) United States
(12) Patent Application Publication
(10) Pub. No.: US 2026/0140846 A1
(43) Pub. Date: May 21, 2026

(54) INTELLIGENT RESOURCE ALLOCATION FOR MULTI-PROCESSING COMPUTING DEVICE PERFORMANCE TRACKING

(71) Applicant: NVIDIA Corporation, Santa Clara, CA (US)

(72) Inventor: Tu Thanh Thai, Taipei City (TW)

(21) Appl. No.: 18/954,728

(22) Filed: Nov. 21, 2024

(51) Int. Cl. G06F 11/34

(52) U.S. Cl. CPC G06F 11/3476; G06F 11/3419

(57) ABSTRACT

Disclosed are apparatuses, systems, and methods for software-agnostic retrievals of telemetry data according to a determined order. The methods include receiving a request from a device to retrieve a plurality of types of telemetry data from a plurality of computing devices, wherein each type of telemetry data of the plurality of types of telemetry data is associated with a telemetry priority. The methos further include determining an ordered list of the plurality of types of telemetry data based on the telemetry priority of each of the plurality of types of telemetry data, and causing the plurality of types of telemetry data to be retrieved for the device from the plurality of computing devices according to the ordered list.

### TECHNICAL FIELD

At least one embodiment pertains to monitoring performance of processing resources running computational applications. For example, at least one embodiment pertains to monitoring performance of multi-processing computing devices that run computational applications.

### BACKGROUND

Modern processing devices, such as central processing computing devices (CPUs), graphics processing computing devices (GPUs), parallel processing computing devices (PPUs), data processing units (DPUs), and/or similar processing devices, are typically equipped to provide types of telemetry data to a source for computing device health management. For example, a specialized management controller may be embedded into the same chip or board that contains the processing devices. The management controller includes logic circuitry and memory and operates responsive to instructions stored in firmware to provide an interface between system-management software, e.g., operation system and BIOS, and the managed processing device. The management controller facilitates efficient management of processing devices, network controllers, and/or the like. As the complexity of processing devices increases, various controller functions and their embodiments likewise become increasingly more complex.

### BRIEF DESCRIPTION OF DRAWINGS

FIG. 1 is a schematic block diagram of an example computing system capable of deploying a microcontroller for managing one or more component devices, according to at least one embodiment;

FIG. 2 illustrates an example data flow of between computing devices and the telemetry management controller of FIG. 1, according to at least one embodiment;

FIG. 3 illustrates example priority groups assembled by the computing system into an ordered list during a time window, according to at least one embodiment.

FIG. 4 is a flow diagram of an example method facilitating software-agnostic retrieval of types of telemetry data from various computing devices and components of computing devices, according to at least one embodiment;

FIG. 5 is a flow diagram of an example method of prioritizing telemetry data processing, according to at least one embodiment; and

FIG. 6 depicts a block diagram of an example computer device capable of supporting software-agnostic facilitating software-agnostic retrieval of types of telemetry data from various computing devices and components of computing devices, according to some embodiments of the present disclosure.

### DETAILED DESCRIPTION

The present disclosure is directed to obtaining telemetry data updates of computing devices such as CPUs, GPUs, DPUs, PPUs, etc. Telemetry data may include, for example, temperature data, cooling fan speed data, power status data, operating status data, etc., for the computing devices. Telemetry data updates can be obtained to ensure that the various computing device performance characteristics remain within target ranges.

Some existing systems monitor performance characteristics of the computing machines by utilizing a CPU to retrieve telemetry data for the components executing the computations. Existing CPUs typically have no logic or hierarchy that prioritizes retrieval of telemetry data collection in an efficient manner. Instead, the CPU traditionally retrieves all telemetry data, as quickly as possible, to ensure all high priority types of telemetry data are retrieved in a timely manner. Following collection of all telemetry data once, the retrieval can immediately start over to collect all telemetry data again as quickly as possible. The CPU, in communication with multiple components, could be in a constant state of retrieval, collecting low priority types of telemetry data more frequently than is necessary to meet the demands of the high priority types of telemetry data retrieval. This results in CPU resources being dedicated to unrequired data retrieval and prevents CPU usage for other processes. This can require additional CPU resources or alternative processing mechanisms to be included in the computing machines.

Aspects and embodiments of the instant disclosure address these and other technological challenges by disclosing methods and systems that support efficient retrieval of types of telemetry data from various computing devices by creating a smart retrieval order based on time intervals, thereby improving computing resource utilization by, for example, freeing up resources for tasks beyond telemetry data retrieval. In some embodiments, a telemetry management controller (TMC) is used that is configured and/or otherwise programmed to prioritize types of telemetry data based on a desired telemetry data update time (e.g., an interval). The TMC can manage telemetry data collection from one or more computing devices, support input-output (IO) functions and perform other functions. The TMC can collect data from various sensors built into the computing devices. In some embodiments, the TMC can receive a request for telemetry data updates of computing devices. The request can identify types of telemetry data of the computing devices and intervals at which the types of telemetry data should be updated. Upon receiving the request, the TMC can group the types of telemetry data based upon the intervals to identify priority groups. Rather than collect all three types of telemetry data within the shortest interval, the TMC can determine an intelligent order to optimize CPU usage.

To generate the order, the TMC may first identify a least common multiple of the intervals provided in the request. The least common multiple can become a time window. The time window can be a length of time in which the order can be executed in its entirety.

In at least one embodiment, to generate the order, the TMC can determine the total number of retrievals to be completed by the CPU in the time window. This number may not equal the summation of the requested types of telemetry data but may instead take into consideration how often each of the types of telemetry data needs to be retrieved during the time window. The total number can be calculated per priority group to ensure every type of telemetry data required in a specific time interval is collected exactly once during that time interval. To identify the total number of retrievals, the TMC can find the summation of the ratio between the least common multiple and the interval multiplied by the number of types of telemetry data in the priority group.

In some embodiments, the TMC can determine how frequently to collect each retrieval within each group. The first group, for example, may need to be collected more frequently than each retrieval in the third group. To calculate the time between retrievals in each group, the TMC can take the interval for that group and divide it by the number of requests. In at least one embodiment, the TMC can arrange the types of telemetry data in an order such that the types of telemetry data are retrieved to efficiently utilize the CPU.

Accordingly, aspects of the present disclosure can intelligently and efficiently retrieve telemetry data such that the computing resources of the CPU are utilized the minimum amount required. Intelligent collection can allow the CPU resources to execute other tasks, advantageously lessening the number of CPU resources required by a system.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as small language models (SLMs) and large language models (LLMs) (which may process text, voice, image, and/or other data types to generate outputs in one or more formats), systems implemented at least partially using cloud computing resources, systems for performing generative AI operations, and/or other types of systems.

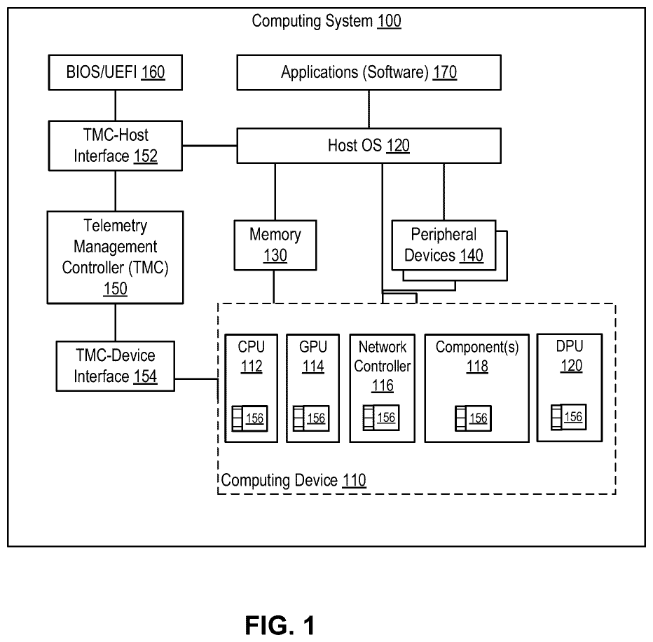

FIG. 1 is a schematic block diagram of an example computing system 100 capable of deploying a controller (e.g., microcontroller) for managing one or more component devices, according to at least one embodiment. As depicted in FIG. 1, computing system 100 may include one or more computing devices 110, such as one or more CPUs 112, one or more GPUs 114, one or more network controllers 116, data processing computing devices (DPU) 120, and/or other component devices (not shown in FIG. 1 for conciseness), as may be deployed by computing system 100, e.g., parallel processing computing devices (PPU), multimedia processors, neural network accelerators, field-programmable gate arrays (FPGA), application-specific integrated circuits (ASIC), and/or the like.

In some embodiments, computing devices may be managed using a telemetry management controller (TMC) 150, which may include logic circuitry and internal memory (not shown) storing instructions (e.g., firmware and/or software instructions) that implement management functionality of TMC 150. In some embodiments, TMC 150 may be embedded in a motherboard that hosts one or more computing devices 110. In some embodiments, TMC 150 may be a baseboard management controller (BMC). TMC 150 may communicate with a host via an TMC-host interface 152 and may communicate with computing devices 110 via an TMC-device interface 154. In some embodiments, TMC-host interface 152 and TMC-device interface 154 may use the same communication protocol, e.g., management component transport protocol (MCTP) or some other protocol. TMC-host interface 152 may facilitate interaction with a host operating system (OS) 120 and with Basic Input/Output System (BIOS) or Unified Extensible Firmware Interface (UEFI) 160. For example, BIOS/UEFI 160 may provide instructions for TMC 150 during the booting process and may pass control over TMC 150 to host OS 120 after the booting process has been completed. In one example embodiment, when computing system 100 is being powered up (or rebooted), BIOS/UEFI 160 may generate instructions to TMC 150 to begin configuring and monitoring operations of various computing devices 110, including but not limited to directing retrieval for one or more types of telemetry data from computing devices 110, initializing address space of CPU 112, GPU 114, network controller 116, component(s) 118, DPU 120, monitoring temperature and clock frequencies of CPU 112, GPU 114, component(s) 118, collecting network metrics from network controller 116, and/or the like. Component(s) 118 can be processing computing devices or modules of computing devices 110. For example, component(s) 118 can include, but are not limited to, power supply computing devices, tensor processing computing devices, field-programmable gate arrays, application-specific integrated circuits, digital signal processors, neural processing computing devices, and vision processing computing devices, or any combination of the aforementioned. Computing devices 110 can be, in some embodiments, data processors, sensors, cameras, microphones, internet of things devices, drones, equipment, monitoring devices, or the like. As the TMC 150 of the computing system 100 is booting, retrieval protocols for one or more types of telemetry data may be identified within the TMC 150. Retrieval protocols may cause the TMC 150 to request types of telemetry data at one or more intervals from computing devices 110. Telemetry data can be, in some embodiments, information that is collected, transmitted, and/or measured from a source or device such as computing devices 110. Correspondingly, retrieval protocols may indicate to TMC 150 that certain types of telemetry data generated at the computing devices 110 (e.g., the GPU 114) may require prioritization based on the one or more time intervals.

In some embodiments, telemetry data retrieved by the TMC 150 from the computing devices 110 can be data generated by CPU 112, GPU 114, network controller 116, component(s) 118, DPU 120, or can be data stored on computing devices 110 and generated internal or external to the computing devices 110. The telemetry data can be identified as types of telemetry data that is associated with a performance characteristic of the computing devices 110. For example, in some embodiments a type of telemetry data can be a temperature for GPU 114. Additional examples of types of telemetry data can include, but are not limited to, response time processing throughput, CPU 112 usage, memory usage, disk I/O utilization, latency, error rate, load handling, power consumption, thermal performance, bandwidth, data transfer rates, and the like.

After host OS 120 is instantiated and has begun executing one or more applications 170, it may generate subsequent instructions to TMC 150. For example, once computing devices 110 have started computational processes, retrieval settings for one or more types of telemetry data for the one or more computing devices 110 may change. Correspondingly, host OS 120 may indicate to TMC 150 that certain types of telemetry data generated at the computing devices 110 (e.g., the GPU 114) may require additional or altered prioritization based on one or more time intervals. During execution of applications 170, host OS 120 may use system memory 130 and any number of peripheral devices 140, e.g., displays, printers, cameras, speakers, microphones, input-output devices (keyboards, pointing devices, touchscreens, and/or the like), sensors (e.g., Mobile Industry Processor Interface sensors communicating over a Gigabit Multimedia Serial Link), and so on. In some embodiments, host OS 120 may support any number of virtual machines (each having a separate guest OS), container-based execution, remote-access execution, and/or the like.

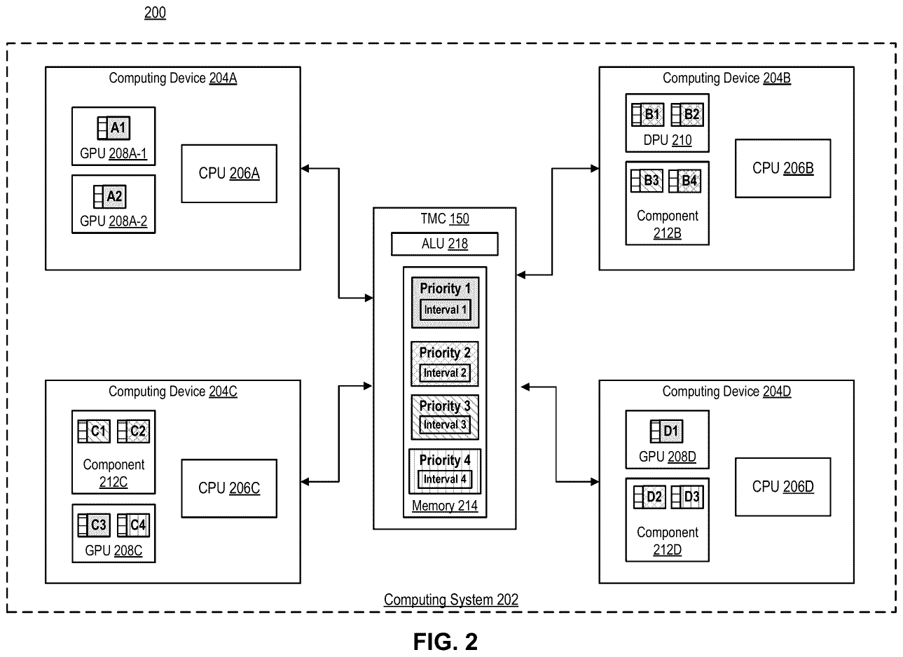

FIG. 2 illustrates an example data flow 200 of computing system 202, an example part of the computing system 100 of FIG. 1, according to at least one embodiment. As illustrated in FIG. 2, TMC 150 may communicate data with computing device 204, e.g., using any suitable external protocol (MCTP, etc.). Computing device 204 may be a computing device that can include one or more units such as a CPU 206, GPU 208, DPU 210, Component 212, and/or the like. As shown, a computing system can include computing devices 204A, 204B, 204C, 204D, where each of the computing devices 204 can include the same or different combinations of units. The computing system 202 may send and receive data from an external device such as user device 110 or from an internal device such as host 102 of FIG. 1.

Each computing device 204 may serve as an endpoint of the network and may be assigned a unique hardcoded endpoint identifier (EID). TMC 150 may be given a separate EID. TMC 150 may maintain an outbound queue (out-queue) of messages addressed to various computing devices 204 of computing system 202. A message may be identified by an EID of a destination computing device DEST_EID, a TAG (e.g., a unique identifier of a message), TO (TAG owner, e.g., a bit or some other value identifying whether the TAG was originated by the source or the destination of the message), and/or any other applicable identifying information. Messages may be sent to computing devices 204 over any suitable physical protocol (e.g., I²C, I³C, PCIe, SMBus, and/or the like) in an order of retrieval required by TMC 150 or in any other order as may be scheduled by TMC 150.

TMC 150 serves as an intelligent controller for accessing and returning telemetry data from one or more computing devices 204 to an end destination. In some embodiments, TMC 150 is configured and/or otherwise programmed to prioritize types of telemetry data based on a desired telemetry data update time (e.g., an interval). More specifically, the TMC 150 can receive a request for telemetry data updates of computing devices 204 (e.g., units) from an internal source such as host 102 or an external source such as a user device. The request can identify types of telemetry data of computing devices 204 and intervals at which the types of telemetry data should be updated. Upon receiving the request, the TMC 150 can group the types of telemetry data based upon the intervals to identify priority groups. As shown, the TMC 150 can, in some embodiments, have memory 214 that stores types of telemetry data into priority groups according to an associated interval such as priority 1, priority 2, priority 3, and priority 4. For example, a request can identify four types of telemetry data, the first, priority 1, to be collected every 100 ms, the second, priority 2, every 250 ms, the third, priority 3, every 500 ms, and the fourth, priority 4, every 1000 ms. Rather than collect all four types of telemetry data every 100 ms, the TMC 150 can determine an intelligent order to optimize CPU 206 and TMC 150 usage.

To generate the order, the TMC 150 may first identify a least common multiple of the intervals provided in the request. In the example above, the least common multiple would be 1000 ms. The least common multiple can become a time window. The time window can be a length of time in which the order can be executed in its entirety. Therefore, the order could be completed every 1000 ms and could be repeated thereafter.

Next, to generate the order, the TMC 150 can determine the total number of retrievals to be directed by the TMC 150 in the time window. This number may not equal the summation of the requested types of telemetry data but may instead take into consideration how often each of the types of telemetry data needs to be retrieved during the time window. For example, as shown, computing device 204A includes two types of telemetry data to be acquired, A1 from GPU 208A-1 and A2 from GPU 208A-2. Computing device 204B includes four types of telemetry data to be acquired, B1 and B2 from DPU 210 and B3 and B4 from Component 212B. Computing device 204C includes four types of telemetry data to be acquired, C1 and C2 from Component 212C and C3 and C4 from GPU 208C. Computing device 204D includes three types of telemetry data to be acquired, C1 from GPU 208D and D2 and D3 from component 212D. In this example, there are 13 types of telemetry data to be retrieved from the computing devices 204 by the TMC 150.

In some embodiments, a priority group can include types of telemetry data from one or more computing devices 204. For example, priority group 1 includes A1 and A2 from computing device 204A, C3 from computing device 204C, and D1 from computing device 204D for four total types of telemetry data in priority group 1. Further, priority group 2 includes five total types of telemetry data, priority group 3 includes 2 total types of telemetry data, and priority group 4 includes 2 total types of telemetry data.

In some embodiments, the total number of retrievals can be calculated at the arithmetic logic unit (ALU) 218 of the TMC 150. The total number can be found per priority group to ensure every type of telemetry data required in a specific time interval is collected exactly once during that time interval. To identify the total number of retrievals, the TMC 150 can find or otherwise determine the summation of the ratio between the least common multiple and the interval multiplied by the number of types of telemetry data in the priority group.

The total number of retrievals can be expressed by

$$\sum ( ( \frac{LCM}{Interval ( n )} ) * n ) = TNR .$$

For example, priority 1 would contribute ((1000/100)*4)=40 retrievals to the summation. The second group would contribute ((1000/250)*5)=20 retrievals to the summation. The third group would contribute ((1000/500)*2)=4 retrievals to the summation. The fourth group would contribute ((1000/1000)*2)=2 retrievals to the summation. The resulting total would be 40+20+4+2=66 total retrievals during the 1000 ms window of time.

Next, the TMC 150 at ALU 218 can determine how frequently to collect each retrieval within each priority group. Types of telemetry data in priority 1, for example, may need to be collected more frequently than each retrieval of types of telemetry data in the priority 3. The time between retrievals in each group can be expressed by

$$\frac{Interval ( n )}{Priority Group Retrivals} = Freq .$$

The TMC 150 at ALU 218 can determine the frequency. For example, priority group one may be evaluated as 100/4=25 ms, or one retrieval for a type of telemetry data in priority group one every 25 ms. The second group would have a retrieval for a type of telemetry data in priority group two every 250/5=50 ms. The third group would have a retrieval for a type of telemetry data in priority group three every 500/2=250 ms. The fourth group would have a retrieval for a type of telemetry data in priority group four every 1000/2=500 ms.

Finally, the TMC 150 at ALU 218 can arrange all the types of telemetry data in an order such that the types of telemetry data are retrieved exactly as many times as required by the interval associated with the respective priority group for each of the types of telemetry data, efficiently utilizing CPUs 206 and TMC 150.

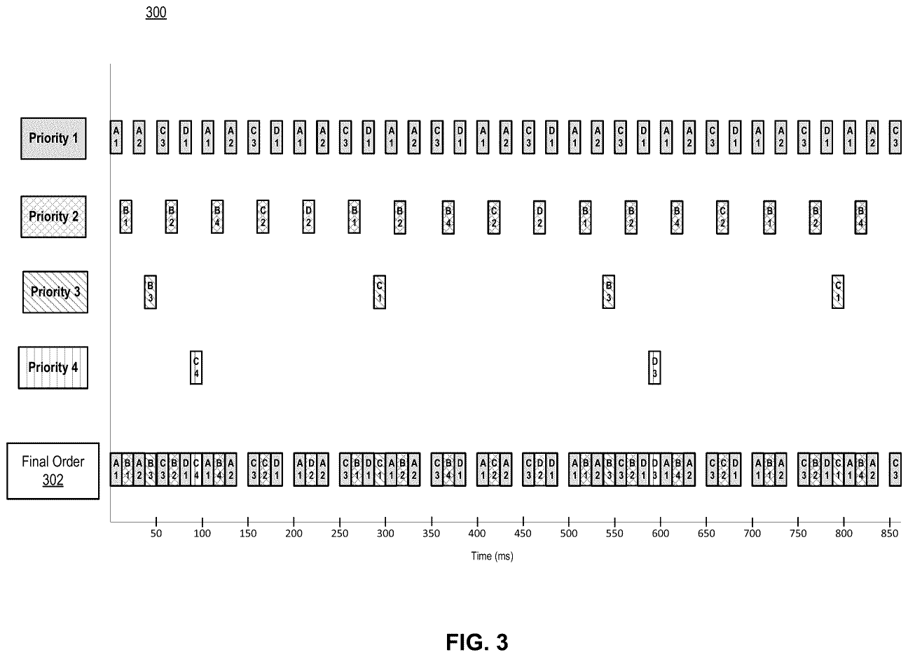

FIG. 3 illustrates example priority groups assembled into an ordered list 300 during a time window of the computing system 200, according to at least one embodiment. As shown in FIG. 2, a plurality of types of telemetry data can be collected at the TMC 150 from one or more computing devices 204. As shown in FIG. 2, the TMC 150 can retrieve the types of telemetry data in a way that limits overuse of computing device 204, CPU 206, and TMC 150 processing resources.

To determine the final order, the TMC 150 can utilize information including, but not limited to, the frequency, total number of retrievals, priority group retrievals, and the time window. In some embodiments, the TMC 150 can order the priority group 1 retrievals first. Using the identified frequency, the TMC 150 can space out the priority group retrievals for group 1 through the time window. For example, for a time interval of 100 ms, number of retrievals of 4, time window of 1000 ms, and a frequency of 25 ms, the TMC 150 can space out the retrievals according to the priority 1 line of FIG. 3. Next, order priority group 2. Using the identified frequency, the TMC 150 can space out the priority group retrievals for group 2 through the time window. For example, for a time interval of 250 ms, number of retrievals of 5, time window of 1000 ms, and a frequency of 50 ms, the TMC 150 can space out the retrievals such that a retrieval of each type occurring in priority 2 occurs once every 50 ms. In spacing out the retrievals for priority group 2, the TMC 150 can schedule around the schedule for priority group 1 and ensure no two retrievals will be scheduled to be retrieved simultaneously. As shown in FIG. 3, the first retrieval for priority 2 occurs after the first retrieval for priority 1, but prior to the second retrieval of priority 1. As shown, the retrieval is indicated as extending over a certain time according to the graph. However, in some embodiments, the time for retrievals may be longer or shorter than is shown and the first retrieval of priority 2 may occur just after the first retrieval of priority 1 is complete.

Using the identified frequency, the TMC 150 can space out the priority group retrievals for priority group 3 through the time window. For example, for a time interval of 500 ms, number of retrievals of 2, time window of 1000 ms, and a frequency of 250 ms, the TMC 150 can space out the retrievals to occur once every 250 ms for each type in Priority 3. In spacing out the retrievals for priority group 3, the TMC 150 schedule around the schedule for priority group 1 and priority group 2 to ensure no two retrievals will be scheduled to be retrieved simultaneously. As shown in FIG. 3, the first retrieval for priority 3 occurs after the first retrieval for priority 2.

Using the identified frequency, the TMC 150 can space out the priority group retrievals for priority group 4 through the time window. For example, for a time interval of 1000 ms, number of retrievals of 2, time window of 1000 ms, and a frequency of 500 ms, the TMC 150 can space out the retrievals to occur once every 1000 ms for each type within Priority 4. In spacing out the retrievals for priority group 3, the TMC 150 schedule around the schedule for priority group 1, priority group 2, and priority group 3 to ensure no two retrievals will be scheduled to be retrieved simultaneously. As shown in FIG. 3, the first retrieval for Priority 4 occurs after the first retrieval for priority 3. Priority 1, priority 2, priority 3, and priority 4 can, in some embodiments be combined to create one final order 302.

In some embodiments, limiting retrieval of types of telemetry data to occur only once during the interval can efficiently utilize the processor executing retrievals. The limitation can, in some embodiments create a rest time in the final order 302. A rest time can allow the device to execute a task unrelated to the telemetry request or telemetry data retrieval. Rest times can be calculated as time between retrievals and, in some embodiments, be adjusted based on a processing time of the unrelated task. An example of a rest time is shown just before 150 ms of the final order 302.

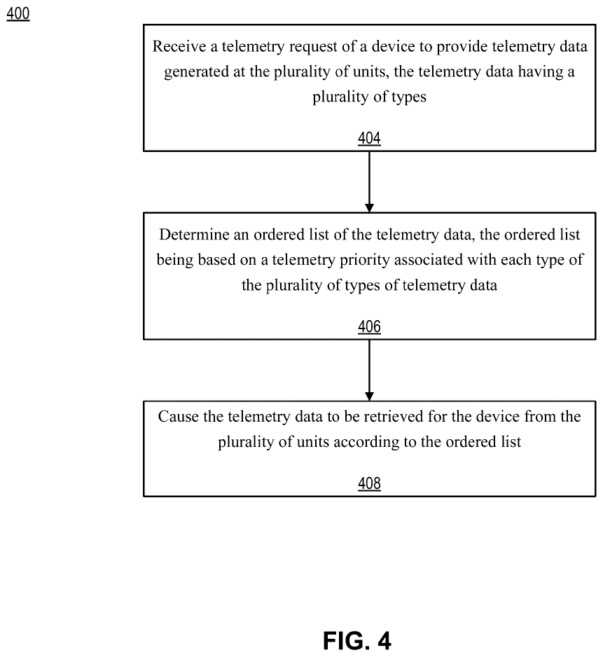

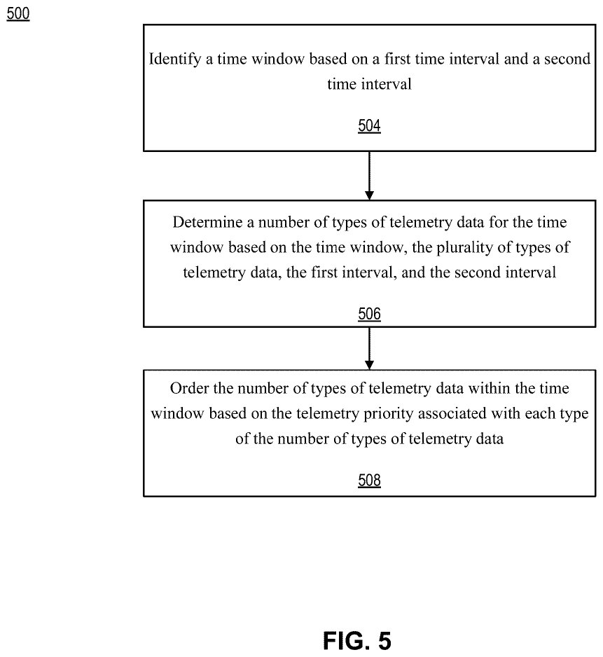

FIG. 4 is a flow diagram of example method 400 facilitating software-agnostic retrieval of types of telemetry data from various computing devices and components of computing devices, according to some embodiments of the present disclosure. FIG. 5 is a flow diagram of an example method of prioritizing telemetry data processing, according to at least one embodiment.

Methods 400 and/or 500 may be performed in the context of cloud-based programming, computational simulations, autonomous driving applications, industrial control applications, provisioning of streaming services, video monitoring services, computer-vision based services, artificial intelligence and machine learning services, mapping services, gaming services, virtual reality or augmented reality services, and many other contexts, and/or in systems and applications for providing one or more of the aforementioned services. Methods 400 and/or 500 may be performed using one or more processing devices (e.g., CPUs, GPUs, accelerators, PPUs, DPUs, etc.), which may include (or communicate with) one or more memory devices. In some embodiments, methods 400 and/or 500 may be performed using computing system 100, one or more computing devices 110, and telemetry management controller 150. In some embodiments, some of the processing units performing any operations of methods 400 and/or 500 may be executing instructions (e.g., firmware or software) stored on non-transient computer-readable storage media. In some embodiments, some of the processing computing devices performing any of the operations of methods 400 and/or 500 may be hardware circuits that operate without software involvement. In some embodiments, any of methods 400 and/or 500 may be performed using multiple processing threads, individual threads executing one or more individual functions, routines, subroutines, or operations of the methods. In some embodiments, processing threads implementing any of methods 400 and/or 500 may be synchronized (e.g., using semaphores, critical sections, and/or other thread synchronization mechanisms). Alternatively, processing threads implementing any of methods 400 and/or 500 may be executed asynchronously with respect to each other. Various operations of any of methods 400 and/or 500 may be performed in a different order compared with the order shown in FIG. 4 and/or FIG. 5. Some operations of any of methods 400 and/or 500 may be performed concurrently with other operations. In some embodiments, one or more operations shown in FIG. 4 and/or FIG. 5 may not always be performed.

Referring to FIG. 4, at block 404, one or more processors executing method 400 may receive a telemetry request of a device to provide telemetry data generated at a plurality of units. In some embodiments, the plurality of units can be CPU 112, GPU 114, Network Controller 116, Components 118, and DPU 120 of FIG. 1. The telemetry request may be generated at a user device (in response to a user request) or an internal device of the telemetry management system. The telemetry request may have a plurality of types. The types may be indications of types of telemetry data processed by the telemetry management system. For example, a type may pertain to particular performance characteristics of units. The telemetry request may further include a priority associated with each respective type. For example, a type may be a temperature or power consumption. The telemetry request may include an indication that the temperature type has a first priority and the power consumption has a second priority. The telemetry request may further identify a check time associated with each priority. For example, any type that is associated with the first priority may be monitored, such that it is checked every 5 ms, whereas any type that is associated with the second priority may be monitored such that it is checked every 10 ms. The telemetry management system may store the telemetry request alone or along with one or more default priorities and check times for types. Default priorities and check times for types may be set to a default priority or a default check time for a type that is used in absence of a telemetry request directed to and/or including a priority or check time for that type. In some embodiments, telemetry requests can replace one or more defaults for types including preset priority.

At block 406, the one or more processors executing method 400 may determine an ordered list of the telemetry data. The ordered list may be based on the telemetry priority associated with each type of the plurality of types of telemetry data received as part of the telemetry request. The telemetry priority may be the same for telemetries provided from a computing device or may be different for types of telemetries from a computing device. In some embodiments, the ordered list may include a single retrieval of a first instance of telemetry data associated with a first type and a single retrieval of a second instance of telemetry data associated with a second type or may include multiple retrievals of the first instance of telemetry data and a single retrieval of the second instance of telemetry data.

At block 408, the one or more processors executing method 400 may cause the telemetry data to be retrieved for the device from the plurality of units according to the ordered list. In some embodiments, as discussed above, telemetry data is retrieved and evaluated at the TMC 150, and the evaluation is then provided to the device. In some embodiments, the telemetry data is retrieved and provided to an intermediary component for evaluation, the evaluation then provided to the device. The intermediary component can be, for example, an internal telemetry data evaluation tool, an external telemetry data evaluation tool, a user device, a host device, or the like. In some embodiments, the telemetry data is retrieved and provided to the device for evaluation.

Determining an ordered list of the telemetry data of block 406 of FIG. 4 can, in some embodiments, include additional operations as shown in method 500 of FIG. 5. Referring to FIG. 5, at block 504, to determine the ordered list of telemetry data, one or more processors executing method 500 may first identify a time window based on a first time interval and a second time interval. The first time interval and the second time interval may be, in some embodiments, associated with a type of telemetry data. For example, the first time may be 5 ms and the second time may be 10 ms. The time window may be identified as a least common multiple of the first time and the second time. In the example, the time window may be 10 ms. In an additional example, the first time may be 8 ms and the second time may be 15 ms. The time window may then be identified as the least common multiple of 8 and 15 which is 120. Therefore, the time window may be 120 ms.

At block 506, the one or more processors executing method 500 may determine a number of types of telemetry data for the time window. The number of types of telemetry data may indicate how many retrievals of a first type of telemetry data may occur during the time window. For example, if the first type is associated with the first time of 5 ms and the time window is 10 ms, the telemetry data associated with the first type may be retrieved twice during the time window. In an additional example, if the first type is associated with the first time of 8 ms with the time window of 120 ms, the telemetry data associated with the first type may be retrieved 15 times during the time window. The number of types may additionally, or alternatively, indicate how may retrievals of a second type of telemetry data may occur during the time window. For example, if the second type is associated with the second time of 10 ms and the time window is 10 ms, the telemetry data associated with the first type may be retrieved once during the time window. In an additional example, if the second type is associated with a second time of 15 ms with the time window of 120 ms, the telemetry data associated with the second type may be retrieved 8 times during the time window.

At block 508, the one or more processors executing method 500 may order the number of types of telemetry data within the time window based on the telemetry priority associated with each type of the number of types of telemetry data. After determining how many retrievals of telemetry data of each type will occur during a given time window, the retrievals can be arranged in a logical manner according to the priority. In some embodiments, types associated with the first time interval may be spaced throughout the time window. In some embodiments, as discussed above, the TMC 150 is used to determine the time between retrievals of telemetry data associated with the first priority, where the TMC 150 may determine a first time distance for the first priority by dividing the time window by the number of retrievals of a first type that are to occur during the time window. For example, the first type retrieved 15 times during a 120 ms time window may be retrieved every 8 ms. Next, in the time between retrievals of telemetry data associated with the first type, the TMC 150 can arrange to retrieve telemetry data associated with the second type. For example, the second type retrieved 8 times during the 120 ms time window may be retrieved every 15 ms and can occur between the retrievals of the telemetry data associated with the first type.

In some embodiments, the first priority can include multiple types of telemetry data and the multiple types of telemetry data may be ordered together according to the first time interval and the time window. In some embodiments, the TMC 150 can retrieve all telemetry data within the ordered list iteratively, such that it can repeatedly restart the time window during which the telemetry data is to be retrieved from the plurality of units according to the ordered list. In some embodiments, the TMC 150 can determine one or more rest times within the ordered list when the TMC 150 is not scheduled to retrieve telemetry data from a unit of the plurality of units. The rest time can occur after a retrieval of one of the plurality of types of telemetry data from two or more of the plurality of units and or a retrieval of two or more of the plurality of types of telemetry data from one of the plurality of units. The rest time can occur after one retrieval of one type and before another of the same type, after one retrieval of one type and before another of a different type, after two retrievals of different types, and/or after multiple retrievals. The retrievals may occur from the same or different units of the plurality of units. The rest time can be used to perform a task unrelated to retrieving telemetry data and executing telemetry requests. In some embodiments, the rest time can be adjusted based on a processing time of the unrelated task.

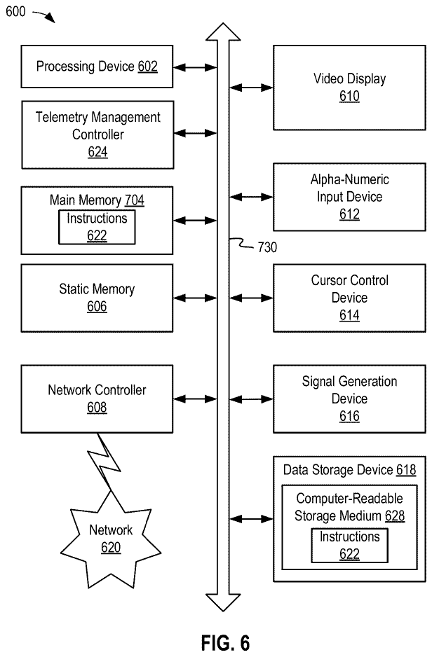

FIG. 6 depicts a block diagram of an example computer device 600 capable of supporting software-agnostic facilitating software-agnostic retrieval of types of telemetry data from various computing devices and components of computing devices, according to some embodiments of the present disclosure. Example computer device 600 can be connected to other computer devices in a LAN, an intranet, an extranet, and/or the Internet. Computer device 600 can operate in the capacity of a server in a client-server network environment. Computer device 600 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 600 can include a processing device 602 (also referred to as a processor), a main memory 604 (e.g., read-only memory (ROM), flash memory, dynamic random access memory (DRAM) such as synchronous DRAM (SDRAM), etc.), a static memory 606 (e.g., flash memory, static random access memory (SRAM), etc.), and a secondary memory (e.g., a data storage device 618), which can communicate with each other via a bus 730.

Processing device 602 represents one or more general-purpose processing devices such as a microprocessor, central processing computing device, or the like. More particularly, processing device 602 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 can also be one or more special-purpose processing devices such as a GPU, a PPU, a DPU, an ASIC, an FPGA, a DSP, network processor, or the like.

Example computer device 600 can further comprise a network controller 608, which can be communicatively coupled to a network 620. Example computer device 600 can further comprise a video display 610 (e.g., a liquid crystal display (LCD), a touch screen, or a cathode ray tube (CRT)), an alphanumeric input device 612 (e.g., a keyboard), a cursor control device 614 (e.g., a mouse), and an acoustic signal generation device 616 (e.g., a speaker).

Example computer device 600 can be a host device configured to execute method 500 of facilitating software-agnostic facilitating software-agnostic retrieval of types of telemetry data from various computing devices and components of computing devices. Computing devices may include one or more processing devices 602, network controllers 608, telemetry management controller 624, and/or the like. Telemetry management controller 624 may communicate with the one or more processing devices 602 operating in accordance with embodiments of FIGS. 1-5.

Data storage device 618 can include a computer-readable storage medium (or, more specifically, a non-transitory computer-readable storage medium) 628 on which is stored one or more sets of executable instructions 622.

Executable instructions 622 can also reside, completely or at least partially, within main memory 604 and/or within processing device 602 during execution thereof by example computer device 600, main memory 604 and processing device 602 also constituting computer-readable storage media. Executable instructions 622 can further be transmitted or received over a network via network interface device 608.

While the computer-readable storage medium 628 is shown in FIG. 6 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing computing device (“CPU”) executes some of instructions while a graphics processing computing device (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computing system comprising:
a plurality of computing devices; and
a telemetry management controller communicatively coupled to the plurality of computing devices, wherein the telemetry management controller is configured to:
receive a request to retrieve a plurality of types of telemetry data from the plurality of computing devices, wherein each type of telemetry data of the plurality of types of telemetry data is associated with a telemetry priority;
determine an ordered list of the plurality of types of telemetry data based at least on the telemetry priority of each of the plurality of types of telemetry data; and
cause the plurality of types of telemetry data to be retrieved for the request from the plurality of computing devices according to the ordered list.

2. The computing system of claim 1, wherein the request further includes a time interval for each type of telemetry data, wherein the time interval is a first interval or a second interval different from the first interval.

3. The computing system of claim 2, wherein the telemetry management controller is further configured to:
identify a time window based on the first interval and the second interval; and
determine a total number of types of telemetry data for the time window based at least on the time window, the plurality of types of telemetry data, the first interval, and the second interval.

4. The computing system of claim 2, wherein the telemetry management controller is further configured to:
determine a first time distance for a first portion of the plurality of types of telemetry data associated with a first interval and a second time distance for a second portion of the plurality of types of telemetry data associated with a second interval different than the first interval.

5. The computing system of claim 4, wherein the telemetry management controller is configured to determine the ordered list using at least the first time distance and the second time distance.

6. The computing system of claim 1, wherein the plurality of computing devices includes one or more of a graphics processing computing device, a data processing computing device, or a smart device.

7. The computing system of claim 1, wherein the telemetry management controller is further configured to:
identify a rest time in the ordered list, wherein the rest time occurs between two retrievals; and
be utilized during the rest time for a non-request purpose.

8. The system of claim 7, wherein the rest time includes a time between a completion of a first request and a second request adjusted by a processing time.

9. The system of claim 8, wherein the telemetry management controller is further configured to begin re-retrieving the plurality of types of telemetry data at an end of a time window.

10. A telemetry management controller comprising:
one or more processors configured to execute instructions, the instructions causing the telemetry management controller to:
receive a request to retrieve a plurality of types of telemetry data from a plurality of computing devices, wherein each type of telemetry data of the plurality of types of telemetry data is associated with a telemetry priority;
determine an ordered list of the plurality of types of telemetry data based at least on the telemetry priority of each of the plurality of types of telemetry data; and
cause the plurality of types of telemetry data to be retrieved for the request from the plurality of computing devices according to the ordered list.

11. The telemetry management controller of claim 10, wherein the request further includes a time interval for each type of telemetry data, wherein the time interval is a first interval or a second interval different from the first interval.

12. The telemetry management controller of claim 11, wherein the one or more processors are further configured to execute instructions causing the telemetry management controller to:
identify a time window based on the first interval and the second interval; and
determine a total number of types of telemetry data for the time window based at least on the time window, the plurality of types of telemetry data, the first interval, and the second interval.

13. The telemetry management controller of claim 11, wherein the one or more processors are further configured to execute instructions causing the telemetry management controller to:
determine a first time distance for a first portion of the plurality of types of telemetry data associated with a first interval and a second time distance for a second portion of the plurality of types of telemetry data associated with a second interval different than the first interval.

14. The telemetry management controller of claim 13, wherein the one or more processors are configured to determine the ordered list using at least the first time distance and the second time distance.

15. The telemetry management controller of claim 10, wherein the one or more processors are further configured to execute instructions causing the telemetry management controller to:
identify a rest time in the ordered list, wherein the rest time occurs between two retrievals; and
be utilized during the rest time for a non-request purpose.

16. The telemetry management controller of claim 15, wherein the rest time includes a time between a completion of a first request and a second request adjusted by a processing time.

17. A method for retrieving telemetry data, the method comprising:
receiving a request to retrieve a plurality of types of telemetry data from a plurality of computing devices, wherein each type of telemetry data of the plurality of types of telemetry data is associated with a telemetry priority;
determining an ordered list of the plurality of types of telemetry data based at least on the telemetry priority of each of the plurality of types of telemetry data; and
causing the plurality of types of telemetry data to be retrieved for the request from the plurality of computing devices according to the ordered list.

18. The method of claim 17, wherein the request further includes a time interval for each type of telemetry data, wherein the time interval is a first interval or a second interval different from the first interval.

19. The method of claim 18, further comprising:
identifying a time window based on the first interval and the second interval; and
determining a total number of types of telemetry data for the time window based at least on the time window, the plurality of types of telemetry data, the first interval, and the second interval.

20. The method of claim 18, further comprising:
determining a first time distance for a first portion of the plurality of types of telemetry data associated with a first interval and a second time distance for a second portion of the plurality of types of telemetry data associated with a second interval different than the first interval.
